(19) United States
(12) Patent Application Publication
(10) Pub. No.: US 2016/0337327 A1
(43) Pub. Date: Nov. 17, 2016

(54) METHOD FOR MANAGING A NODE ASSOCIATION IN A WIRELESS PERSONAL AREA COMMUNICATION NETWORK

(71) Applicants: TELECOM ITALIA S.P.A., Milano (IT); UNIVERSITA' DEGLI STUDI DI NAPOLI FEDERICO II, Napoli (IT)

(72) Inventors: Claudio BOREAN, Torino (IT); Claudio PETRAZZUOLO, Pisa (IT); Andrea RANALLI, Rome (IT)

(73) Assignees: TELECOM ITALIA S.P.A., Milano (IT); UNIVERSITA' DEGLI STUDI DI NAPOLI FEDERICO II, Napoli (IT)

(21) Appl. No.: 15/107,342

(22) PCT Filed: Dec. 30, 2013
(86) PCT No.: PCT/EP2013/078107

§ 371 Date: Jun. 22, 2016

(51) Int. Cl. H04L 29/06; H04W 12/04; H04W 12/08; H04W 4/00; H04W 52/04

(52) U.S. Cl. CPC H04L 63/062; H04W 4/008; H04W 52/04; H04W 12/08; H04L 63/1475; H04W 12/04

(57) ABSTRACT

It is disclosed a method for associating a new node with a wireless personal area communication network, said communication network comprising a number of nodes. The method comprises: providing, among the nodes of the communication network, a configuration node; operating the configuration node to allow association of the new node with the network; operating the other nodes to disallow association of the new node with the network; and at the configuration node, upon reception of a request from the new node to join the network, sending to the new node a network key at a reduced transmit power.

### TECHNICAL FIELD

The present invention relates to the field of wireless personal area communication networks, in particular, but non exclusively, ZigBee communication networks. In particular, the present invention relates to a method for securely managing the association of a node with a wireless personal area communication network.

### BACKGROUND ART

As known, the IEEE 802.15.4 standard defines the physical layer and media access control layer for wireless personal area networks (WPANs). Examples of wireless personal area communication networks are ZigBee communication networks and IPv6 over Low power (6LoWPAN) communication networks.

In particular, the ZigBee technology is used for low-power, low-rate wireless communications. Examples of wireless personal area networks implementing the ZigBee technology are home automation networks for managing household appliances, light switches, electrical meters, TV and music devices, and so on.

A ZigBee communication network typically comprises a number of nodes arranged in a mesh configuration. Typically, transmission distances are below about 100 m.

Communication within the ZigBee network is, as known, subject to a security model based on the usage of cryptographic keys for encrypting the messages exchanged between the nodes of the network.

In the following, the term “message” may refer to a data frame, a data packet, a protocol data unit or the like carrying data to be exchanged among the nodes of a communication network. The expression “securing a message” will refer to an operation of encrypting the content of the message by using a cryptographic key.

As known, two types of cryptographic keys are used in a ZigBee network: a network key, which is shared amongst all devices of the network and used to secure communications, and link keys. A link key is shared between two devices of the network and is used to secure the unicast communication between the two devices.

In a ZigBee network, one node, usually referred to as “coordinator”, is responsible for starting the network. Moreover, typically, the coordinator acts as a “trust center” storing network keys and controlling accesses to the network by new nodes. The trust center may randomly generate the network key and it could periodically update its value. The other nodes of the network are ZigBee devices joining the network to share data and receive commands by a user of the network. In the following, the expression “user of the network” may in particular indicate the network owner or the network installer.

The nodes of the ZigBee network may be either ZigBee end devices (e.g. the sensors) or ZigBee routers. The ZigBee routers provide intermediate communication between the coordinator and the ZigBee end devices. Each ZigBee end device only communicates with one ZigBee router (or the coordinator) at a time. The coordinator and the routers of a ZigBee network are typically mains powered, while the other devices may be battery powered.

In the following description and in the claims, the expression “associate a new node with the network” will be referred to a procedure according to which a new node, which is currently not comprised within the network, is put in the conditions to join the network and communicate with the other nodes of the network. Typically, the association procedure, according to a “standard security mode” (see sections 4.6.2.2. and 4.6.3.2.1.1 of the current Zigbee Specification developed by the ZigBee Alliance, Document 053474r20, in the following referred to simply as “ZigBee Specification”), comprises a first stage during which the new node joins the network (see, for instance, the ZigBee Specification, section 4.6.3.1) and a second stage during which the joiner node is authenticated (see, for instance, the ZigBee Specification, section 4.6.3.2).

In particular, according to the IEEE 802.15.4 standard, a node wishing to be associated with a network sends a request to join the network in the form of a beacon request broadcast message. The beacon request broadcast message is received by the nodes of the network close to the joining node, in particular it is received by the ZigBee routers and by the coordinator. One of these node then acts as parent node i.e. the node, if enabled, may allow association of the new node with the network. In other words, the parent node may accept the request to join sent by the new node. Typically, in a WPAN, nodes are enabled to allow association of new nodes with the network by intervention of the user, which may set a dedicated attribute (i.e. the macAssociationPermit attribute) residing in the PAN Information Base (FIB) of the MAC sub-layer of each node to a TRUE/FALSE status. If the macAssociationPermit attribute of a node is set to TRUE, then the node (either the coordinator or a ZigBee router in a ZigBee network) may allow association of new nodes with the network, while, on the contrary, if the macAssociationPermit attribute of a node is set to FALSE, the node disallow association of new nodes with the network. In particular, in a ZigBee network, the default status of the macAssociationPermit attribute is typically set to FALSE, and the user may operate the nodes of the network (the coordinator and the ZigBee routers) to change the macAssociationPermit attribute to TRUE when a new node wants association. This operation by the user may be performed, for instance, by pressing a button on a device (e.g., a hand-held appliance) already comprised in the ZigBee network. Alternatively, the user may press a virtual button on a graphical user interface installed on a user's device (e.g. a PC, a tablet, a smartphone, etc.), the device cooperating with the ZigBee network. This way, a command is sent from the device to the nodes of the ZigBee network to switch their macAssociationPermit attributes to TRUE, at least temporarily.

The node which acts as parent node allows association of the new node with the network and accepts the request to join sent by the new node. However, in order to be able to communicate within the ZigBee network, the new node must be authenticated. During the authentication stage, the new node should receive the network key from the trust center. If the parent node is the coordinator acting as trust center, it directly sends the network key to the new node. Otherwise, if the parent node is a ZigBee router, it communicates with the trust center in order to get the network key, and then it forwards the network key to the new node, possibly via other intermediate ZigBee routers.

In the following description and in the claims, the expression “join the network” will refer to the operations according to which a new node sends a request to join the network, selects a parent node and interacts with it until reception of a response indicating that the request to join is accepted. Moreover, an “authenticated node” is a node that successfully joined the network and is put in the condition of communicating with the other nodes by using the network key.

US2009/0177889 discloses a communication system and method for securely and efficiently sharing a link key for security and authentication in a ZigBee network. Upon receipt of an access request from an end device, a trust center sends a public key to the end device, and upon receipt of the public key, the end device encrypts an arbitrary key using the public key, and sends the encrypted arbitrary key to the trust center. The trust center generates a link key using the arbitrary key, and sends the link key to the end device.

### SUMMARY OF THE INVENTION

The inventors noticed that during the procedure described above in relation to the association of a new node with wireless personal area network, in particular a ZigBee network, a vulnerability issue may arise. Indeed, as described above, the new node should receive the network key from the trust center, possibly via the parent node and other intermediate nodes of the ZigBee network. However, while data transmissions between the trust center and the other, pre-existing, nodes of the network are secured by using the network key, the data transmission between the parent node and the new node can not be secured using the network key, which is unknown to the new node. In order to ensure interoperability, every node in a Zig Bee network is pre-configured with a link key, called “default global trust center link key”, which is used for securing the message transporting the network key from the parent node to the new node (see, e.g., section 4.6.3.2.1.1 of the Zigbee Specification). The value of the default global trust center link key is 5A 69 67 42 65 65 41 6C 6C 69 61 6E 63 65 30 39 (2igBeeAlliance09′).

The inventors noticed that the message transporting the network key may be intercepted by devices not belonging to the ZigBee network (e.g. malicious network sniffers), which may then decrypt the network key using the known default trust center link key, and use the decrypted network key to intercept the other messages exchanged amongst the nodes of the ZigBee network. This is a procedure typically used by commercial ZigBee packet sniffers to decode data exchanged in a ZigBee network. This configures as a violation of the security of the ZigBee network and the user privacy. On the other hand, intercepting the message containing the encrypted network key sent by the parent node to the new node is possible because, as cited above, the transmission power of the ZigBee devices is such that the coverage area is up to about 100 m and hence the message can be sniffed also from the exterior of the user's house.

In view of the above, the inventors have addressed the problem of providing a method for managing the association of a new node with a wireless personal area communication network, in particular, but not exclusively, a ZigBee communication network, which allows to enhance the security of the network. In particular, the inventors have addressed the problem of providing a method for managing the association of a new node with a wireless personal area communication network, in particular, but not exclusively, a ZigBee communication network, which allows avoiding the risk that the message containing the network key sent by the parent node to the new node is maliciously intercepted and the network key is decrypted by devices that do not belong to the network.

According to a first aspect, the present invention provides a method for associating a new node with a wireless personal area communication network, the communication network comprising a number of nodes, the method comprising:
a) providing, among the nodes of the communication network, a configuration node;
b) operating the configuration node to allow association of the new node with the network;
c) operating the nodes other than the configuration node to disallow association of the new node with the network; and
d) at the configuration node, upon reception of a request from the new node to join the network, sending to the new node a network key at a reduced transmit power.

Preferably, the method further comprises bringing the new node and the configuration node at a relative distance ranging between about 0 m and 2 m.

Profitably, the reduced transmit power is such that the configuration node is able to send the network key to the new node up to a distance ranging between 0 m and 2 m.

Preferably, the reduced transmit power ranges between about −50 dBm and about −30 dBm.

More preferably, the reduced transmit power is equal to about −50 dBm.

Preferably, at step c) operating is performed by the configuration node.

Preferably, operating is triggered by an intervention of a user of the wireless personal area communication network.

Preferably, at step c) operating comprises sending a command from the configuration node to each of the nodes other the said configuration node so that a respective attribute indicating whether the node is enabled to allow the new node to join the communication network (N) is set to FALSE.

Preferably, the method further comprises before step b) and after step d), keeping the configuration node switched off and switching on the configuration node only before step b).

According to a second aspect, the present invention provides a wireless personal area communication network comprising a number of nodes among which a configuration node is provided,

wherein the configuration node is configured to be operated to allow association of a new node with the network,

wherein the nodes other than the configuration node are configured to be operated to disallow association of the new node with the network,

wherein the configuration node is further configured to, upon reception from the new node of a request to join the network, send to the new node a network key at a reduced transmit power.

Preferably, the configuration node is a stand-alone portable device.

More preferably, the configuration node is battery powered.

Alternatively, the configuration node is integrated within one of the nodes other than the configuration node.

Preferably, the wireless personal area communication network is a ZigBee communication network.

Preferably, the reduced transmit power has a value between about −50 dBm and about −30 dBm.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows an exemplary ZigBee communication network according to an embodiment of the present invention;

FIG. 2 schematically shows a flow chart of the method according to the present invention;

FIG. 3 schematically shows a procedure according to which a new node is associated with a ZigBee communication network according to an embodiment of the present invention; and

FIG. 4 is a flow chart representing the operation of a configuration node according to an embodiment of the present invention.

Detailed description of preferred embodiments of the invention

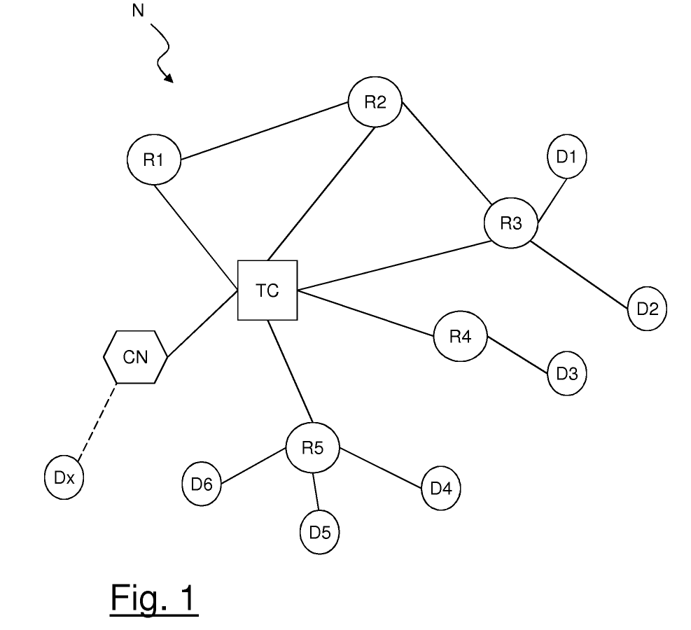

FIG. 1 schematically shows a wireless personal area communication network N.

The network N comprises a number of nodes. In particular, the exemplary network N of FIG. 1 comprises a coordinator node which is configured to act as a trust center, i.e. to manage a network key, which is the cryptographic key used to secure messages exchanged within the network N. This node will be referred to in the following simply as “trust center” and is indicated in FIG. 1 as TC. The network N further comprises eleven other nodes, and in particular five routers R1, R2, R3, R4, R5, and six end devices D1, D2, D3, D4, D5, D6.

Although in the exemplary network N the coordinator is configured to act as the trust center, another node which is not the coordinator may alternatively be configured to act as the trust center in the network N.

The trust center TC, the routers R1, . . . , R5 and the end devices D1, . . . , D6 are preferably connected according to a mesh topology. Within the network N, each end device D1, . . . , D6 is preferably connected to one router R1, . . . , R5, as exemplarily shown in FIG. 1. Preferably, the nodes of the network N are configured to transmit data at a working transmit power ranging between about 0 dBm (1 mW) and about 17 dBm (50 mW). The nodes of the network N may all operate at the same working transmit power or at different respective working transmit powers within the range described above.

The nodes of the network N are preferably configured to exchange data and commands in the form of data frames. As described above, the data frames exchanged within the network N may be secured using the network key, which is shared amongst the nodes of the network N and is transmitted to every node joining the network N at the end of an association procedure, as it will be described herein after. Each node is then equipped with a default pre-configured link key having a known value.

According to preferred embodiments of the present invention, the network N further comprises a configuration node CN.

The configuration node CN is preferably in the form of a stand-alone portable device, like, e.g., a key fob, and is preferably battery powered. Alternatively, the configuration node CN may be integrated into one of the other nodes of the network N or in an apparatus, such as an Internet gateway, cooperating with the network N. Within the network N, the configuration node CN has preferably the same functionalities as a router.

The nodes of the network N, in particular the trust center TC, the configuration node CN and the routers R1-R5 are configured to be enabled to allow association of new nodes with the network N (i.e. they may act as parent nodes for a new node whishing to be associated with the network N).

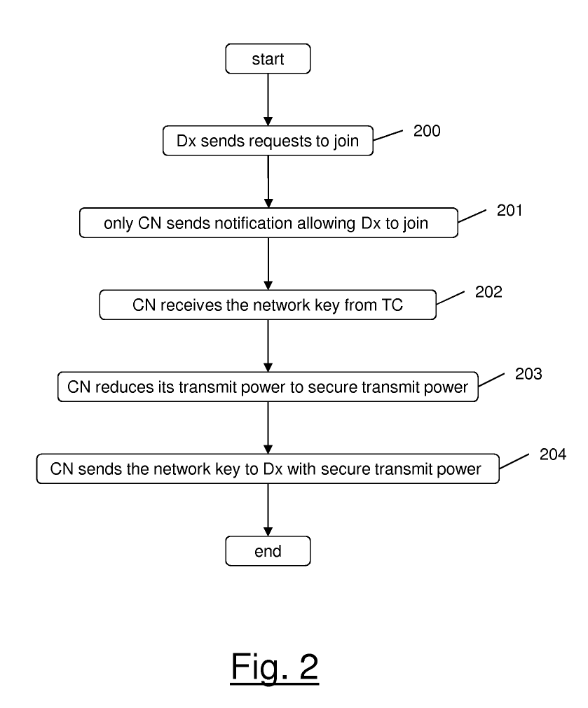

FIG. 2 schematically illustrates the steps of a method for associating a new node Dx with the network N, according to embodiments of the present invention.

The method according to the present invention provides for bringing the new node Dx that the user wishes to associate with the network N in the vicinity of the configuration node CN. In particular, the new node DX and the configuration node CN are preferably brought at a relative distance ranging between about 0 m and 2 m.

Then the new node Dx preferably sends requests to join the network N to the nodes of the network N (step 200), in particular to the trust center TC, the routers R1-R5 and the configuration node CN, i.e. to the nodes that in principle may act as parent node for the new node Dx.

According to the present invention, the configuration node CN is the only node of the network N enabled to allow association of the new node Dx with the network N. The configuration node CN may be pre-configured to allow association of any new node with the network N, or it may be operated by the user of the network N, before receiving the request to join from the new node Dx, to be enabled to allow association of the new node Dx with the network N, as it will be described in greater detail herein after.

Before receiving the request to join from the new node Dx, the other nodes TC, R1-R5 are preferably operated so that they disallow association of the new node Dx with the network N. In order to do this, the other nodes TC, R1-R5 of the network N are preferably pre-configured to disallow association of any new node with the network N. Alternatively, the configuration node CN may send a command to the other nodes TC, R1l-R5 of the network N so that they are operated to disallow association of the new node Dx with the network N, as it will be described in greater detail herein after.

According to the present invention, the configuration node CN acts as parent node for the new node Dx and accepts the request to join of the new node Dx. In particular, at step 201, the configuration node CN sends to the new node Dx a response indicating that the configuration node CN is enabled to allow association of the new node Dx with the network N. At step 202, the configuration node CN preferably sends a request to the trust center TC (possibly via other nodes of the network N) for receiving the network key. Then, the trust center TC preferably sends the network key to the configuration node CN, possibly via other nodes of the network N. Preferably, the network key sent by the trust center TC to the configuration node CN is comprised within a data frame that is encrypted by using the network key. Then, at step 202, the configuration node CN preferably decrypts the data frame containing the network key and issues a further data frame comprising the network key, which is encrypted using the default pre-configured link key.

At step 203, before sending this further data frame to the new node Dx, the configuration node CN preferably reduces its transmit power. In particular, the configuration node CN preferably reduces its transmit power to a secure transmit power value such that it may transmit data up to a distance ranging between about 0 m and 2 m. At step 204, the configuration node CN preferably sends to the new node Dx the further data frame containing the network key by using the secure transmit power. The new node Dx is then actually associated with the network N in that it may use the network key to encrypt future communications from the new node Dx to the other nodes of the network N.

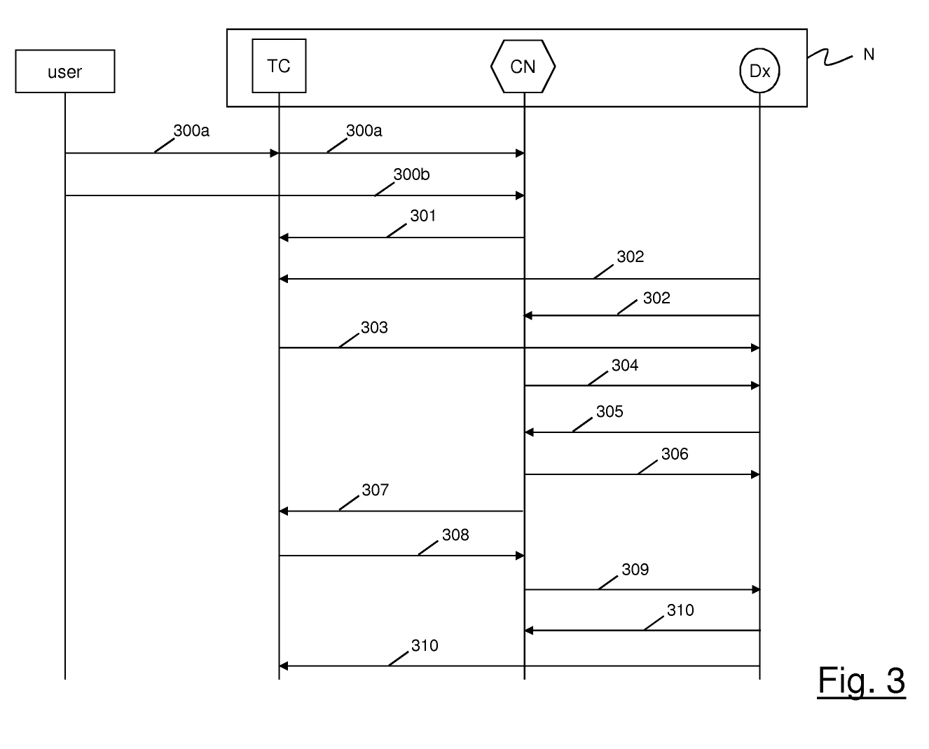

FIG. 3 schematically illustrates in more detail the steps of the flowchart of FIG. 2, with particular reference to an exemplary ZigBee network.

According to this embodiment, as described above, each node preferably comprises a MAC sub-layer with a PAN Information Base (FIB) containing a macAssociationPermit attribute, which indicates whether the node is enabled to act as parent node for a new node wishing to be associated with the network N. By default, the macAssociationPermit attribute of all the nodes of the network N, in particular the trust center TC, the configuration node CN and the (ZigBee) routers R1l-R5, is preferably set to FALSE. Therefore, upon deployment of the network N, the trust center TC, the configuration node CN and the (ZigBee) routers R1-R5 are preferably not enabled to act as parent nodes and allow association of new nodes with the network N.

It is assumed that the new node Dx is a ZigBee end device. This is not limiting since the procedure described hereinafter may however be applied also in case the new node Dx is a ZigBee router. For sake of simplicity, only some nodes of the network N are represented in FIG. 3 and only their operation will be described in detail (namely, the trust center TC, the configuration node CN and the new node Dx), even if the procedure that will be described in the following may involve other nodes of the network N.

As already described above, when the user of the network N wishes to associate a new node Dx with the ZigBee network N, he/she preferably brings the configuration node CN and the new node Dx in the vicinity one of another, i.e. they are brought to respective positions such that the new node Dx is within a distance from the configuration node CN ranging between about 0 m to 2 m. Then, the user operates the trust center TC, the configuration node CN and the ZigBee routers R1-R5, so that their macAssociationPermit attribute is switched to TRUE, at least temporarily, as it will be explained herein after.

In particular, by intervention of the user (for instance, by pressing a button on the trust center TC or on another device already in the network N, or via a virtual button on a user interface installed on the trust center TC or on another device cooperating with the network N), the macAssociationPermit attribute of the trust center TC is switched to TRUE and a Mgmt_Permit_Joining_req command frame is broadcasted from the trust center TC within the network N, in particular it is sent to the configuration node CN and the ZigBee routers R1-R5, as provided by the ZigBee Specification, section 2.4.3.3.7. This in represented in FIG. 3 at step 300a, where the user interacts with the trust center TC and the Mgmt_Permit_Joining_req broadcast command frame is sent from the trust center TC to the configuration node CN and the ZigBee routers R1-R5. The Mgmt_Permit_Joining_req broadcast command frame preferably contains a PermitDuration parameter higher than 0x00 and lower than or equal to 0xFE. Upon reception of this frame, the configuration node CN and the ZigBee routers R1-R5 switch their macAssociationPermit attribute to TRUE for a number of seconds equal to the value of the PermitDuration parameter. This way, the trust center TC, the configuration node CN and the ZigBee routers R1-R5 are enabled to allow association of new nodes with the network N.

At step 301, the configuration node CN preferably issues and sends a broadcast command to the trust center TC and the ZigBee routers R1-R5 so that their macAssociationPermit attributes are switched to FALSE. In particular, the configuration node CN preferably issues a further Mgmt_Permit_Joining_req command frame containing a PermitDuration parameter equal to 0x00. In this case, upon reception of this frame, the trust center TC and the ZigBee routers R1-R5 switch their macAssociationPermit attributes to FALSE.

This way, all the nodes of the network N that in principle may allow association of new nodes with the network N are disabled to allow association of new nodes with the network N, except the configuration node CN. According to the present invention, after step 301, the only node which is enabled to allow association of new nodes with the network N is the configuration node CN.

According to a variant, when a user wishes to associate a new node Dx with the network N, he preferably operates only the configuration node CN to switch its macAssociationPermit attribute to TRUE. In particular, with reference to FIG. 3, according to this variant, at step 300b the user interacts with the configuration node CN (e.g. by pressing a button) so that the macAssociationPermit attribute of the configuration node CN is set to TRUE. Then, step 301 is preferably performed in order to avoid that either the trust center TC or any of the ZigBee routers R1-R5 may be enabled to allow association of new nodes with the network N (i.e. in case their macAssociationPermit attribute is currently TRUE, after step 301 it is switched to FALSE). Also in this case, the only node which is enabled to allow association of new nodes with the network N is the configuration node CN.

Then, at step 302, the user operates the new node Dx to send a request to join the network CN. The request is sent to all the nodes of the network N in the form of a message containing a beacon request command, according to the IEEE 802.15.4 standard (see, for instance, section 5.3.7 of document IEEE Std 802.15.4™-2011). The beacon request command frame sent by the new node Dx is received by all the nodes of the network N, and, in particular, by the configuration node CN, as depicted in FIG. 3.

Also in this case, the user may operate the new node Dx to send the broadcast beacon request command by, e.g., pressing a button on the new node Dx.

At step 303, the new node Dx preferably receives notifications from the trust center TC, the configuration node CN and the ZigBee routers R1-R5 of the network N indicating whether they are enabled to act as parent node for the new node Dx. The notifications are preferably in the form of beacon frames, as provided by the IEEE 802.15.4 standard (see section 5.2.2.1 of document IEEE Std 802.15.4™-2011) In particular, at step 303, the new node Dx preferably receives a first beacon frame from the trust center TC (and a similar first beacon frame from the ZigBee routers R1-R5 of the network N). Substantially at the same time, at step 304, the new node Dx preferably receives a second beacon frame from the configuration node CN. According to the present invention, the first beacon frame preferably contains an association permit sub-field set to 0 (which means that the macAssociationPermit attribute of the sending node is set to FALSE) indicating that the trust center TC (and any ZigBee router R1-R5) is not enabled to allow association of new nodes with the network N. The second beacon frame preferably contains an association permit sub-field set to 1 (which means that macAssociationPermit attribute of the sending node is set to TRUE) indicating that the configuration node CN is enabled to allow association of new nodes with the network N.

Upon reception of the first beacon frames from the trust center TC and from the ZigBee routers R1-R5 and of the second beacon frame from the configuration node CN, the new node Dx preferably performs a selection of a parent node through which to join the network N on the basis of the information contained in the received first beacon frames and second beacon frame. In particular, according to the present invention, the new node Dx preferably decides to join the network N via the configuration node CN, which is the only node of the network N having the macAssociationPermit attribute set to TRUE.

At step 305, the new node Dx issues and sends to the configuration node CN an association request frame with an association request command, as provided by the IEEE 802.15.4 standard (see section 5.3.1 of document IEEE Std 802.15.4-2006). The association request command of step 305 allows the new node Dx to request joining the network N through the configuration node CN.

At step 306, the configuration node CN preferably issues and sends to the new node Dx an association response frame with an association response command, as provided by the IEEE 802.15.4 standard (see section 5.3.2 of document IEEE Std 802.15.4-2006). The association response command sent at step 306 allows the configuration node CN to communicate to the new node Dx that the configuration node CN is able to allow the new node Dx joining the network N. In other words, upon reception of the association response command frame, the request to join by the new node Dx is accepted.

The messages exchanged among the nodes of the communication network CN and the new node Dx at steps 300a-306 of FIG. 3 are plain text messages, i.e. they are not secured using any cryptographic key.

Upon reception of the the association response command from the configuration node CN, the new node Dx, according to the ZigBee Specification (see section 4.6.3.1), is declared “joined but unauthenticated” to the network. At this point, the new node Dx must be authenticated, i.e., in particular, it must receive the network key. The procedure according to which the new node Dx receives the network key according to the present embodiment is described in detail in the following.

At step 307, the configuration node CN preferably issues and sends to the trust center TC an update device command frame, as provided by the ZigBee Specification, section 4.4.9.3, informing the trust center TC that the new node Dx joined the network N. The update device command frame sent by the configuration node CN to the trust center TC (possibly routed towards the trust center TC by intermediate ZigBee routers of the network N) is secured by using the network key for encryption. Upon reception of the update device command frame, at step 308, the trust center TC preferably sends to the configuration node CN the network key. In particular, the trust center TC preferably issues a transport key command frame, secures this frame by using the network key and embeds the secured transport key frame into a tunnel command which is then sent to the configuration node CN, as provided by the ZigBee Specification, sections 4.4.9.2 and 4.6.3.7.1. The tunneled transport key command frame contains the network key. The tunnel command frame sent by the trust center TC to the configuration node CN (possibly routed towards the configuration nodes CN by intermediate ZigBee routers of the network N) is secured by using the network key for encryption.

Upon reception of the encrypted network key from the trust center TC, the configuration node CN preferably decrypts the frame containing the network key, and issues a further frame, secured by using the default trust center link key, to send the network key to the new node Dx. According to the present invention, this further frame is sent by the configuration node CN at a reduced transmit power with respect to the working transmit power of the nodes of the network N, as it will be explained in detail hereinafter.

In particular, upon reception of the tunnel command frame from the trust center TC, at step 309, the configuration node CN preferably decrypts the tunnel command frame using the network key and extracts the embedded transport key command frame (see the ZigBee Specification, section 4.6.3.7.2). Then, the configuration node CN preferably issues a further transport key command frame by securing the received transport key command frame using the default global trust center link key for encryption. As already described above with reference to step 203 of FIG. 2, before sending the further transport key command frame to the new node Dx, the configuration node CN reduces its transmit power to a reduced value, which will be indicated in the following as “secure transmit power”. The power reduction at the configuration node CN is preferably performed before the configuration node CN sends the further transport key command frame to the new node Dx at step 309. It may however be performed within a time interval starting after the configuration node CN sent the update device command frame to the trust center TC at step 307 and ending before the configuration node CN sends the further transport key command frame to the new node Dx at step 309.

Preferably, the secure transmit power that the configuration node CN uses for sending the further transport key command to the new node Dx ranges from about −50 dBm to about −30 dBm, more preferably it is equal to about −50 dBm. Preferably, the secure transmit power of the configuration node CN is selected in such a way that the configuration node CN may transmit data up to a distance ranging between about 0 m and about 2 m.

Then, at step 309, the configuration node CN preferably sends the further transport key command frame to the new node Dx using the secure transmit power.

After having received the further transport key command frame, the new node Dx preferably retrieves the network key by decrypting the further transport key command frame with the default global trust center link key. At this point, the new node Dx may send messages within the network CN by securing them with the active network key. In particular, the new node Dx preferably sends to the other nodes of the network N, in particular to the trust center TC, a device_annce command frame (see the ZigBee Specification, section 2.4.3.1.11) notifying the other nodes that it has been associated with the network N (step 310).

Advantageously, according to the present invention, the configuration node CN is the only node that may allow association of the new node Dx with the network N. Moreover, the configuration node CN sends to the new node Dx the further transport key command frame, in which the network key is encrypted using the known default global trust center link key, in a secure manner. Indeed, thanks to the fact that the configuration node CN sends the frame with a reduced power, namely the secure transmit power indicated above, only a device which is in the vicinity of the configuration node CN (i.e. within a distance between about 0 m-2 m) may receive the frame with the encrypted network key. This way, the present invention advantageously allows avoiding that another device, which do not belong to the network N and which is not in the vicinity of the configuration node CN, may intercept the network key and violate the security and privacy of the user of the network. Therefore, advantageously, according to the present invention, the vulnerability issue that may arise when a new node wishes to be associated with a wireless personal area communication network, in particular a ZigBee communication network, is avoided.

As described above, according to particularly advantageous embodiments of the present invention, the configuration node CN is a stand-alone portable device, e.g. a key fob. In this case, the configuration node CN may be easily brought by the user in the vicinity of the new node Dx. This guarantees that the further transport key command frame is received only by the new node Dx that is being associated with the network and not by other nodes of the network, much less by devices that do not belong to the network and that may maliciously intercept the network key. Moreover, this embodiment is particularly advantageous in those situations in which the new node Dx can not be easily moved by the user (e.g. the new node Dx is a sensor configured to monitor the power consumption of a household appliance, such as a dishwasher, and the sensor is integrated within the appliance).

After having sent to the new node Dx the network key within the further transport key command frame, the configuration node CN may raise its transmit power from the secure transmit power to its working transmit power and act as a ZigBee router.

It is to be noticed that the procedures described in the foregoing may also be used by a node that belongs to the network N but has missed a network key update and needs to receive the latest network key in a secure manner.

Preferably, according to the present invention, the configuration node CN of the present invention is associated with the network N in a secure manner during a preliminary initialization phase described in the following. According to the present invention, during this preliminary initialization phase, the network N is started by the coordinator (which is assumed, in the present description, to act as trust center). Then, the configuration node CN is associated with the network N according to a procedure performed in a secure environment. In particular, with reference to a ZigBee network, either the configuration node CN may have the network key pre-installed, or it may receive the network key from the trust center TC, as provided in the ZigBee Specification, sections 4.6.3.1 and 4.6.3.2. The operations involved are performed in a secure environment provided by e.g. the user of the network N. This secure environment may be, for instance, a room containing only the nodes of the network involved in the procedure. In this way, the network key possibly sent by the trust center TC to the configuration node CN in an unsecured way is not intercepted by any other device.

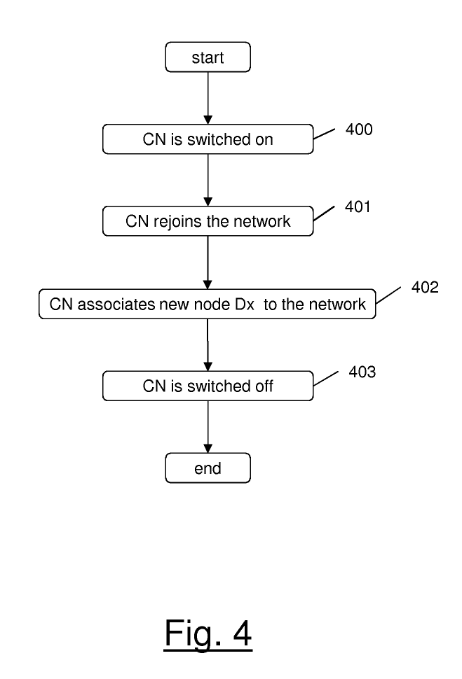

FIG. 4 is a flow chart describing the operation of the configuration node CN according to a further embodiment of the present invention. In the following description, the network N is again, for sake of example, a ZigBee network.

According to this embodiment, the configuration node CN comprises at least one on/off button and an associated led indicating the on/off status of the configuration node CN. The configuration node CN accordingly turns on only when this button is pressed. According to this embodiment of the present invention, in operative conditions of the network N, the configuration node CN is switched off and may be turned on (by the user pressing the on/off button) only when the user of the network N wishes to associate a new node Dx with the network N, as it will be described in greater detail herein after.

When the user wishes to associate a new node Dx with the network N, the user preferably switches on the configuration node CN (step 400). In this situation, a led on the configuration node CN may switch on advising the user that the configuration node CN is turned on.

Then, at step 401, the configuration node CN preferably rejoins the network N. In particular, the configuration node CN issues and sends a rejoin request command frame to its parent node (i.e. any one of the trust center TC and the ZigBee routers R1-R5 which acted as parent node for the configuration node CN), as provided by the ZigBee Specification, section 3.4.6. Then, the configuration node CN preferably receives from its parent node a rejoin response command frame, as provided by the ZigBee Specification, section 3.4.7, indicating that the configuration node CN is allowed to rejoin the network N.

Then, at step 402, the configuration node CN preferably performs the operations already described above for associating the new node Dx with the network N with reference to steps 300b-309 of FIG. 3. In particular, the configuration node CN:
i. switches its macAssociationPermt attribute to TRUE (step 300b);
ii. issues and sends a broadcast command to the trust center TC and the ZigBee routers R1-R5 so that their macAssociationPermit attributes are switched to FALSE (step 301). This operation is performed in order to avoid that either the trust center TC or any of the ZigBee routers R1-R5 may be enabled to allow association of new nodes with the network N (i.e. in case their macAssociationPermit attribute is currently TRUE, after step 301 it is switched to FALSE);
iii. receives a beacon request command frame from the new node Dx (step 302);
iv. sends a beacon frame to the new node Dx (step 304) indicating that it is allowed to associate new nodes with the network N (the new node Dx, as described above with reference to step 303 of FIG. 3, receives beacon frames also from the trust center TC and the ZigBee routers R1-R5 but these beacon frames indicate that the trust center TC and the ZigBee routers R1-R5 are not allowed to associate new nodes with the network N);
v. receives an association request frame from the new node Dx (step 305);
vi. sends an association response frame to the new node Dx (step 306);
vii. sends an update device command frame to the trust center TC (step 307);
viii. receives from the trust center TC a tunnel command frame containing a transport key command frame with the network key (step 308); and
ix. sends a further transport key command frame to the new node Dx with the network key encrypted by using the default trust center link key (step 309), by using the secure transmit power.

At the end of the steps described herein above and after having received the device annce command frame from the new node Dx as described above, the configuration node CN preferably switches off (step 403). Before switching off, the configuration node CN preferably sends a command to the new node Dx so that the new node Dx may, once the configuration node CN is switched off, select another parent node within the network N, namely the trust center TC or anyone of the ZigBee routers R1-R5. In particular, the configuration node CN may send to the new node Dx a leave command frame with a rejoin option set to TRUE (according to the ZigBee Specification, section 3.4.4) to the new node Dx.

Advantageously, this further embodiment allows saving power. Indeed, the configuration node, which may be battery powered, is switched on only in case the user wishes to associate a new node with the network. For the rest of the time, the configuration node may be switched off, so as to greatly save its battery power.

1. A method for associating a new node (Dx) with a wireless personal area communication network (N), said communication network (N) comprising a number of nodes (TC, R1-R5, CN), said method comprising:
a) providing, among said nodes (TC, RI CN) of said communication network (N), a configuration node (CN);
b) operating said configuration node (CN) to allow association of said new node (Dx) with the network (N);
c) operating the nodes (TC, R1-R5) other than said configuration node (CN) to disallow association of said new node (Dx) with the network (N); and
d) at said configuration node (CN), upon reception of a request from said new node (Dx) to join said network (N), sending to said new node (Dx) a network key at a reduced transmit power.

2. The method according to claim 1, wherein it further comprises bringing said new node (Dx) and said configuration node (CN) at a relative distance ranging between about 0 m and 2 m.

3. The method according to claim 2, wherein said reduced transmit power is such that said configuration node (CN) is able to send said network key to said new node (Dx) up to a distance ranging between 0 m and 2 m.

4. The method according to claim 1, wherein said reduced transmit power ranges between about −50 dBm and about −30 dBm.

5. The method according to claim 4, wherein said reduced transmit power is equal to about −50 dBm.

6. The method according to claim 1, wherein at said step c) said operating is performed by said configuration node (CN).

7. The method according to claim 6, wherein said operating is triggered by an intervention of a user of said wireless personal area communication network (N).

8. The method according to claim 6, wherein at said step c) said operating comprises sending a command from said configuration node (CN) to each of said nodes (TC, R1-R5) other than said configuration node (CN) so that a respective attribute indicating whether the node (TC, R1-R5) is enabled to allow the new node (Dx) to join the communication network (N) is set to FALSE.

9. The method according to claim 1, wherein it further comprises before said step b) and after said step d), keeping said configuration node (CN) switched off and switching on said configuration node (CN) only before said step b).

10. A wireless personal area communication network (N) comprising a number of nodes (TC, R1-R5, CN) among which a configuration node (CN) is provided,
wherein said configuration node (CN) is configured to be operated to allow association of a new node (Dx) with the network (N),
wherein said nodes (IC, R1-R5) other than said configuration node (CN) are configured to be operated to disallow association of said new node (Dx) with the network (N),
wherein said configuration node (CN) is further configured to, upon reception from said new node (Dx) of a request to join said network (N), send to said new node (Dx) a network key at a reduced transmit power.

11. The wireless personal area communication network (N) according to claim 10, wherein said configuration node (CN) is a stand-alone portable device.

12. The wireless personal area communication network (N) according to claim 11, wherein said configuration node (CN) is battery powered.

13. The wireless personal area communication network (N) according to claim 10, wherein said configuration node (CN) is integrated within one of said nodes (TC, R1-R5) other than said configuration node (CN).

14. The wireless personal area communication network (N) according to claim 10, wherein said wireless personal area communication network (N) is a ZigBee communication network.

15. The wireless personal area communication network (N) according to claim 10, wherein said reduced transmit power has a value between about −50 dBm and about −30 dBm.
